(19) United States
(12) Patent Application Publication
(10) Pub. No.: US 2014/0299551 A1
(43) Pub. Date: Oct. 9, 2014

(54) DESALINATION SYSTEM AND METHOD

(71) Applicant: General Electric Company, Schenectady, NY (US)

(72) Inventors: Rihua Xiong, Niskayuna, NY (US); Wei Cai, Niskayuna, NY (US); John Harold Barber, Niskayuna, NY (US); Irving David Elyanow, Niskayuna, NY (US); George Randall Jones, Niskayuna, NY (US); Juan Alfredo Zepeda, Niskayuna, NY (US)

(21) Appl. No.: 14/357,464

(22) PCT Filed: Nov. 28, 2011
(86) PCT No.: PCT/US2012/064338

§ 371 Date: May 9, 2014

(30) Foreign Application Priority Data
Nov. 28, 2011 (CN) 201110385034.3

(51) Int. Cl. C02F 9/00; C02F 1/52; C02F 1/469

(52) U.S. Cl. CPC C02F 9/00; C02F 1/4695; C02F 1/52
USPC 210/702; 210/243

(57) ABSTRACT

A desalination system comprises an electrodialysis reversal apparatus configured to receive a first stream for desalination and a second stream to carry away ions removed from the first stream, and a precipitation unit in fluid communication with the electrodialysis reversal apparatus and configured to circulate the second stream therebetween. At least one backwashable filter is disposed between and in fluid communication with the electrodialysis reversal apparatus and the precipitation and configured to filter the second stream in a normal operation mode. A desalination method is also presented.

### BACKGROUND OF THE DISCLOSURE

The invention relates generally to desalination systems and methods for water recovery. More particularly, this invention relates to desalination systems and methods using electrodialysis reversal (EDR) apparatuses for product water recovery.

In industrial processes, large amounts of wastewater, such as aqueous saline solutions are produced. Generally, such saline solutions are not suitable for direct consumption in domestic or industrial applications. In view of limited eligible water sources, de-ionization of streams, such as wastewater, seawater or brackish water, commonly known as desalination, becomes an option to produce eligible water for these applications.

Due to relatively higher efficiency and higher quality of product water, electrodialysis reversal apparatuses have been employed for desalination of such streams. During operation, such streams are introduced into the EDR apparatuses for desalination for product water recovery. Typically, precipitation units are also employed to circulate liquids into the respective EDR apparatuses during desalination of the streams so as to carry away charged species removed from the streams.

However, with the circulation of the liquids between the EDR apparatuses and the respective precipitation units, concentration of salts or other impurities in the liquids increases. This results in particle precipitation occurring in the precipitation units, which may be brought into the EDR apparatuses by the liquids so as to cause scaling or fouling tendency to damage the EDR apparatuses.

There have been attempts to avoid introduction of the particle precipitation into the EDR apparatuses. For example, cartridge filters may be disposed between the precipitation units and the respective EDR apparatuses to filter the particle precipitation before the liquids are introduced into the EDR apparatus. However, the cartridge filters may suffer from low efficiency and high replacement frequency, which results in increasing of operation cost.

In another example, the sizes of the required precipitation units may be large in order to provide additional settling areas for solid-liquid separation so as to reduce possibility of introduction of the particle precipitation into the EDR apparatuses during the circulation of the liquids. However, the large sizes of the precipitation units may cause increasing of required installation space, capital cost and assembly difficulty, which may prohibit them from being widely implemented.

Therefore, there is a need for new and improved desalination system and method for desalination of streams for water recovery.

### BRIEF DESCRIPTION OF THE DISCLOSURE

A desalination system is provided in accordance with one embodiment of the invention. The desalination system comprises an electrodialysis reversal apparatus configured to receive a first stream for desalination and a second stream to carry away ions removed from the first stream, and a precipitation unit in fluid communication with the electrodialysis reversal apparatus and configured to circulate the second stream therebetween. At least one backwashable filter is further disposed between and in fluid communication with the electrodialysis reversal apparatus and the precipitation unit and configured to filter the second stream in a normal operation mode.

A desalination method is provided in accordance with another embodiment of the invention. The desalination method comprises passing a first stream through an electrodialysis reversal apparatus for desalination, passing a second stream through the electrodialysis reversal apparatus via a precipitation unit to carry away ions removed from the first stream, and filtering the second stream by at least one backwashable filter in a normal operation mode before the second stream from the precipitation unit is introduced into the electrodialysis reversal apparatus.

These and other advantages and features will be better understood from the following detailed description of preferred embodiments of the invention that is provided in connection with the accompanying drawings.

### BRIEF DESCRIPTION OF THE DRAWINGS

FIG. 1 is a schematic diagram of a desalination system in accordance with one embodiment of the invention; and

FIG. 2 is a schematic diagram of an assembly of a plurality of backwashable filters in accordance with one embodiment of the invention.

### DETAILED DESCRIPTION OF THE INVENTION

Preferred embodiments of the present disclosure will be described hereinbelow with reference to the accompanying drawings. In the following description, well-known functions or constructions are not described in detail to avoid obscuring the disclosure in unnecessary detail.

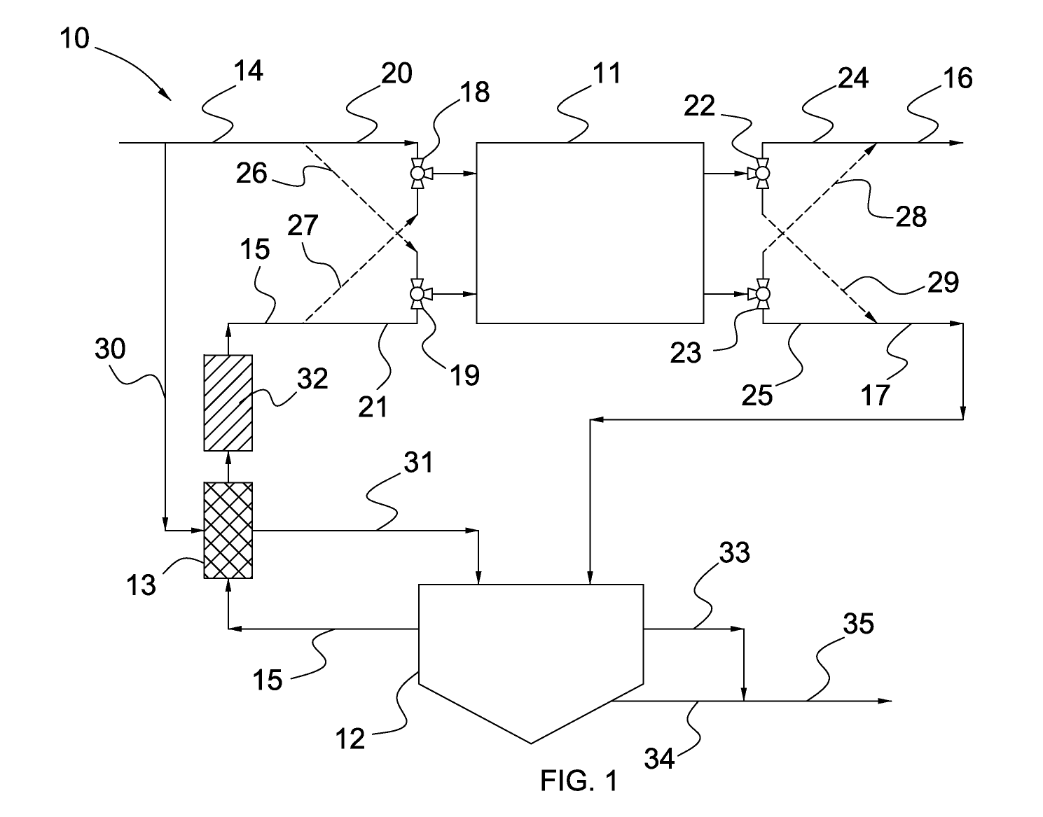

FIG. 1 is a schematic diagram of a desalination system 10 in accordance with one embodiment of the invention. For the illustrated example, the desalination system 10 comprises an electrodialysis reversal (EDR) apparatus 11, a precipitation unit 12 in fluid communication with the EDR apparatus 11, and a (first) backwashable filter 13 disposed between and in fluid communication with the EDR apparatus 11 and the precipitation unit 12.

In embodiments of the invention, the EDR apparatus 11 is configured to receive a first stream 14 having salts or other impurities from a liquid source (not shown) for desalination and to receive a second stream 15 from the precipitation unit 12 during desalination of the first stream 14 so as to carry the charged species (anions and cations) removed from the first stream 14 out of the EDR apparatus 11. In non-limiting examples, the salts ma include charged ions, such as magnesium (Mg²⁺), calcium (Ca²⁺), sodium (Na⁺), chlorine (Cl⁻), and/or other ions.

Thus, a first output stream (a product stream) 16, which may be a dilute liquid coming out of the EDR apparatus 11, may have a lower concentration of the charged species as compared to the first stream 14. A second outflow stream (a concentrated stream) 17 has a higher concentration of charged species than the second stream 15 input into the EDR apparatus 11 from the precipitation unit 12. In some examples, the first output stream 16 may be sent back the EDR apparatus 11 or be sent into other electrical or electrochemical separation apparatuses for further desalination.

In certain applications, the first stream 14 and the second stream 15 may or may not comprise the same salts or impurities, and may or may not have the same concentration of the salts or the impurities. In other examples, the concentration of the salts or impurities in the second stream 15 may or may not be saturated or supersaturated.

As is well known, “EDR” is an electrochemical separation device using anion exchange membranes and cation exchange membranes to remove ions or charged species from water and other fluids under DC current with periodic polarity reversal. In non-limiting examples, other electrochemical separation devices, such as supercapacitor desalination (SCD) devices or electrodialysis (ED) devices may also be used.

In some non-limiting examples, the EDR apparatus 11 comprises a pair of electrodes configured to act as an anode and a cathode, respectively. A plurality of alternating anion- and cation-exchange membranes are disposed between the anode and the cathode to form a plurality of alternating dilute and concentrate channels therebetween. The anion exchange membrane(s) are configured to be passable for anions. The cation exchange membrane(s) are configured to be passable for cations. Additionally, the EDR apparatus 11 includes a plurality of spacers disposed between each pair of the membranes, and between the electrodes and the adjacent membranes.

In some applications, the electrodes may include electrically conductive materials which may or may not be thermally conductive, and may have particles with smaller sizes and large surface areas. In some examples, the electrode may be titanium plate or platinum coated titanium plate. In other examples, the electrically conductive material may include one or more carbon materials. Non-limiting examples of the carbon materials include activated carbon particles, porous carbon particles, carbon fibers, carbon aerogels, porous mesocarbon microbeads, or combinations thereof. In other examples, the electrically conductive materials may include a conductive composite, such as oxides of manganese, or iron, or both, or carbides of titanium, zirconium, vanadium, tungsten, or combinations thereof.

The spacers may comprise any ion-permeable, electronically nonconductive material, including membranes and porous and nonporous materials. In non-limiting examples, the anion exchange membrane may comprise a polymeric material that includes quaternary amine groups. The cation exchange membrane may comprise a polymeric material that includes sulfonic acid groups and/or carboxylic acid groups.

During operation, when the EDR apparatus 11 is in a normal polarity state, while an electrical current is applied to the EDR apparatus 11, liquids, such as the first and second streams 14 and 15 pass through first valves 18 and 19 along first input pipes, as indicated by solid lines 20 and 21 to enter into the respective alternating dilute and concentrate channels, respectively.

In the dilute channels, cations in the first stream 14 migrate through the cation exchange membranes towards the cathode to enter into the adjacent channels. The anions migrate through the anion exchange membranes towards the anode to enter into other adjacent channels. In the adjacent channels (concentrate channels) located on each side of a dilute channel, the cations may not migrate through the anion exchange membranes, and the anions may not migrate through the cation exchange membranes, even though the electrical field exerts a force on the ions toward the respective electrode (e.g. anions are attracted to the positively charged anode). Therefore, the anions and cations remain in and are concentrated in the respective concentrate channels.

As a result, the second stream 15 passes through the concentrate channels to carry the concentrated anions and cations migrating from the dilute channels out of the EDR apparatus 11 so that, the first output stream (a product stream) 16 and the second output stream 17 pass through second valves 22 and 23 and to enter into respective first output pipes, as indicated by solid lines 24 and 25. For some arrangements, the first output stream (a product stream) 16 and the second output stream 17 may have respective lower and higher concentration of the charged species, as compared to the first and second streams 14, 15.

The polarity of the electrodes of the EDR apparatus 11 may be reversed, so as to reduce the scaling and fouling tendency in the EDR apparatus. In the reversed polarity state, the dilute channels from the normal polarity state may act as the concentrate channels to receive the second stream 15, and the concentrate channels from the normal polarity state may function as the dilute channels to receive the first stream 14.

Accordingly, during operation, the first and second streams 14 and 15 may enter the EDR apparatus 11 along respective second input pipes, as indicated by broken lines 26 and 27. The first output stream 16 and the second output stream 17 may flow along respective second output pipes, as indicated by broken lines 28 and 29. For the arrangements of the invention, it should be noted that the EDR apparatus 11 is not limited to any particular electrodialysis reversal (EDR) apparatus for processing a liquid.

As depicted in FIG. 1, the precipitation unit 12 comprises a vessel and is configured to accommodate and introduce the second stream 15 into the EDR apparatus 11 to carry away the charged species removed from the first stream 14 so as to produce the second output stream 17. In the illustrated embodiment, an upper portion (not labeled) of the precipitation unit 12 has a hollow cylindrical shape and a lower portion (not labeled) of the precipitation unit 12 is cone-shaped. Alternatively, the precipitation unit 12 may have other shapes, such as cylindrical or rectangular shapes.

The second output stream 17 is redirected into the precipitation unit 12 from an upper end (not labeled) thereof. Accordingly, the second stream 15 is circulated between the EDR apparatus 11 and the precipitation unit 12 for desalination of the first stream 14. In certain applications, the second output stream 17 may not redirected into the precipitation unit 12, and a liquid source (not show) may be provided to introduce the liquid 15 into the precipitation unit 12.

As the circulation of the liquid 15 continues, the concentration of the salts or other impurities continually increases until the liquid 15 is saturated or supersaturated. As a result, the degree of saturation or the supersaturation may reach a point where particle precipitation occur in the liquid 15 over time. In non-limiting examples, a portion of the upper portion of the precipitation unit 12 may act as a solid-liquid separation space for facilitation of separation of the particle precipitation from the second stream (liquid) 15. During operation, the second stream 15 may be provided or extracted from an upper portion of the solid-liquid separation space of the precipitation unit 12. In other examples, the solid-liquid separation space may or may not be defined.

Thus, during introduction of the second output stream 17 into the precipitation unit 12 from the upper end thereof, at least a portion of the particle precipitation may be separated from the liquid 15 (or from the second output stream 17) in the precipitation unit 12. In some examples, the particle precipitation with diameters larger than a specified diameter may be kept within a defined area (not shown) of the precipitation unit 12 or settle down in the lower portion of the precipitation unit 12. Other particle precipitation with diameters smaller than the specified diameter may be dispersed in the liquid 15.

In some applications, when the liquid 15 is introduced into the EDR apparatus 11 from the precipitation unit 12 without filtration of the particle precipitation dispersed therein, the dispersed particle precipitation may enter into the EDR apparatus 11 to cause fouling or scaling issues. In order to avoid damages to the FOR apparatus 11 during desalination, for the illustrated arrangement, the backwashable filter 13 is disposed between the EDR apparatus 11 and the precipitation unit 12 to filter the liquid 15 so as to remove at least a portion of the particle precipitation from the liquid 15 before the liquid 15 is introduced into the EDR apparatus 11 from the precipitation unit 12.

As used herein, the term “backwashable filter” means a regenerable filter, which may be reused after being flushed by a washing fluid, for example, flushing the filter in a direction opposite to a normal flow direction for filtration of a liquid to be filtered.

In non-limiting examples, the backwashable filter may comprise filtration elements (not shown) for accommodation and filtration of a liquid to be filtered in a normal operation mode, and backwash pipes (not shown) in fluid communication with the fluid filtration elements to supply backwashing fluids to remove filtered materials (which is also referred to as accumulated filtration cake) in the fluid filtration elements out of the backwashable filter for regeneration in a backwash mode. As used herein, the term “a normal operation mode” means a mode in which the backwashable filter is filtering a liquid. The term “a backwash mode” means a mode in which the accumulated filtration cake is flushed out of the backwashable filter. In non-limiting examples, suitable materials used in the filtration elements include poly tetrafluoroethylene (PTFE) because the PTFE filtration elements are easily backflushed due to a low adhesion between the accumulated filtration cake and the PTFE filtration elements.

For the arrangements of the invention, it should be noted that the backwashable filter 13 is not limited to any particular backwashable filter for filtration of the liquid 15. In one example, the backwashable filter 13 may be sold by Pall Corporation in Washington, N.Y. district, U.S.A.

Thus, when the liquid 15 from the precipitation unit 12 pass through the backwashable filter 13 for filtration for introduction into the EDR apparatus 11, at least a portion, of the particle precipitation dispersed in the liquid 15 are filtered. With the filtration of the backwashable filter 13 over time, the filtered particle precipitation may be accumulated therein. In some applications, when the filtered particle precipitation are accumulated to a certain level, the backwashable filter 13 may be switched to the backwash mode from the normal operation mode, so that a washing fluid 30 may be introduced into the backwashable filter 13 to remove the accumulated filtered particle precipitation therein for regeneration of the backwashable filter 13 and produce a discharge fluid 31. In non-limiting examples, the washing fluid 30 may be introduced along a direction opposite to the flow direction of the liquid 15 for introduction into the back washable filter 13.

In the illustrated example, the washing fluid 30 and the first stream 14 are provided by the same (a single) water source, so that a portion of the first stream 14 may act as the washing fluid 30. Alternatively, the washing fluid 30 may be provided by the precipitation unit 12 or other water sources. The discharge fluid 31 may or may not be introduced into the precipitation unit 12.

After filtration using the backwashable filter 13, a concentration of the particle precipitation in the liquid 15 may be lower. As depicted in FIG. 1, a filter 32 may be also disposed between and in fluid communication with the backwashable filter 13 and the EDR apparatus 11 to act as a backup filter for further filtration of the liquid 15 from the backwashable filter 13. In non-limiting examples, the filter 32 may comprise a backwashable filter or a once-through filter, for examples, a cartridge filter. in one example, the filter 32 comprises a cartridge filter.

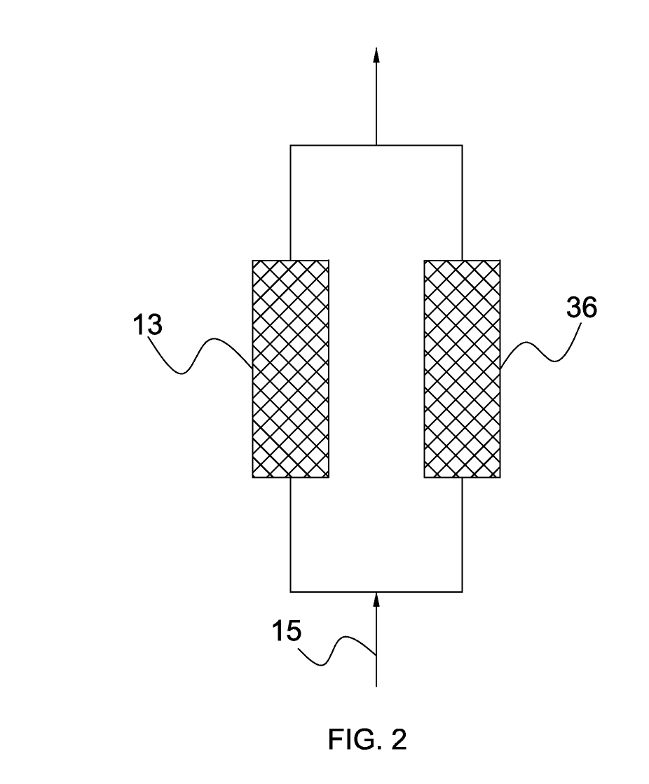

In some applications, in order to facilitate continuous operation of the desalination system 10, as depicted in FIG. 2, a second backwashable filter 36 is disposed parallel to the first backwashable fitter 13 for filtration of the liquid 15 from the precipitation unit 12. Thus, when the first backwashable filter 13 is in the backwash mode, the second backwashable filter 36 may be in the normal operation mode for filtration for continuous and stable operation of the desalination system 10. In certain applications, more than two backwashable filters may be disposed in parallel so as to cooperate to facilitate continuous and stable operation of the desalination operation.

In certain examples, a certain amount of a stream 33 may be removed from the liquid 15 in the precipitation unit 12 from the upper portion of the the precipitation unit 12 to maintain a constant volume and/or reduce the degree of saturation or supersaturation of some species in the precipitation unit 12. The stream 33 may be mixed with a stream 34 removed from the lower portion of the precipitation unit 12 to form a discharge stream 35.

In some embodiments, the precipitation of the salts or other impurities may not occur until the degree of saturation or supersaturation thereof is relatively very high. Accordingly, in certain examples, seed particles (not shown) may be added into the precipitation unit 12 to induce the precipitation on surfaces thereof at a lower degree of supersaturation of the salts or other impurities. In certain applications, the seed particles may comprise solid particles including, but not limited to CaSO₄ particles and their hydrates to induce the precipitation.

In embodiments of the invention, the desalination system 10 employs the backwashable filter(s) to filter the liquid 15 from the precipitation unit 12 before the liquid 15 is introduced into the EDR apparatus 11 so as to avoid scaling or fouling tendency therein for facilitating stable operation thereof. Compared to conventional desalination systems employing once-through filters, such as cartridge filters, the backwashable filters have a higher tolerance of loading of the particle precipitation. The employment of the backwashable filters may improve the system efficiency and reduce the cost due to relatively higher replacement frequency of the cartridge filters in the conventional desalination systems.

In addition, in some conventional desalination systems without the backwashable filters, precipitation vessels thereof may have large sizes to define a solid-liquid separation space so that at least a portion of the particle precipitation may be separated from the liquid for setting down therein so as to avoid or alleviate scaling or fouling tendency after the liquid from the precipitation vessels is introduced into the EDR apparatus. Generally, an engineering parameter, which is referred to as “rising rate”, may be used to determine the sizes of the solid-liquid separation space in a precipitation unit. By definition, the rising rate is a superficial upward linear flow velocity when extracting the liquid from the upper portion of the liquid-solid separation space. It is a ratio of extracting flow rate to the sectional area of the liquid-solid separation space.

For example, in some conventional desalination systems, without the backwashable filters, the rising rate is typically designed to be smaller than 0.50 gallon per minute per square feet, for example, 0.25 gallon per minute per square feet, in order to ensure a suitable level of the solid-liquid separation performance so as to decrease the replacement frequency of disposable cartridge filters employed in the conventional desalination systems.

In embodiments of the invention, since the backwashable filters have a higher tolerance of loading of the particle precipitation, the sizes of the precipitation units 12 may be reduced. In one non-limiting example, with the employment of the backwashable filter 13, the rising rate of the precipitation unit 12 is designed to be greater than 0.50 gallon per minute per square feet, for example, 0.75 gallon per minute per square feet. In other examples, the rising rate of the precipitation unit 12 may be designed to be greater than 1.0 gallon per minute per square feet, for example, 1.5 gallon per minute per square feet.

With a greater rising rate, the solid-liquid separation space in the precipitation unit 12 may be reduced. For example, when the rising rate of the precipitation unit 12 increases from 0.25 gallon per minute per square feet to 1.50 gallon per minute per square feet, compared to the precipitation unit in the conventional desalination system without the backwashable filter, the volume of the solid-liquid separation space of the precipitation unit 12 is reduced by about 83%, which indicates the sizes of the precipitation unit 12 is reduced greatly. In certain applications, the precipitation unit 12 may even eliminate the solid-liquid separation space due to the employment of the backwashable filter 13.

Thus, due to reduction of the sizes of the solid-liquid separation space of the precipitation unit, the footprint of the precipitation unit may be reduced. At the same time, the capital cost of the precipitation unit may be saved and assembly difficulty may be decreased, and the flexibility of the system may also be improved. In industrial applications, the desalination system may be easily implemented and cost-effective while having higher efficiency and performance.

While the disclosure has been illustrated and described in typical embodiments, it is not intended to be limited to the details shown, since various modifications and substitutions can be made without departing in any way from the spirit of the present disclosure. As such, further modifications and equivalents of the disclosure herein disclosed may occur to persons skilled in the art using no more than routine experimentation, and all such modifications and equivalents are believed to be within the spirit and scope of the disclosure as defined by the following claims.

What is claimed is:

1. A desalination system, comprising:
an electrodialysis reversal apparatus configured to receive a first stream for desalination and a second stream to carry away ions removed from the first stream,
a precipitation unit in fluid communication with the electrodialysis reversal apparatus and configured to circulate the second stream therebetween; and
at least one backwashable filter disposed between and in fluid communication with the electrodialysis apparatus and the precipitation unit and configured to filter the second stream in a normal operation mode.

2. The desalination system of claim 1, wherein the at least one backwashable filter comprises a filtration element, and wherein the filtration element comprises polytetrafluoroethylene.

3. The desalination system of claim 1, wherein the at least one backwashable filter is further configured to receive a washing fluid for backwashing and produce a discharge liquid in a backwash mode.

4. The desalination system of claim 3, wherein the first stream and the washing fluid are provided by a single water source.

5. The desalination system of claim 3, wherein the discharge stream from the at least one backwashable filter is configured to be introduced into the precipitation unit.

6. The desalination system of claim 1, further comprising a filter disposed between and in fluid communication with the at least one backwashable filter and the electrodialysis reversal apparatus and configured to filter the second stream from the at least one backwashable filter.

7. The desalination system of claim 6, wherein the filter comprises a cartridge filter.

8. The desalination system of claim 1, wherein the desalination system comprises a plurality of backwashable filters disposed in parallel with each other to filter the second stream from the precipitation unit.

9. The desalination system of claim 1, wherein the precipitation unit comprises a solid-liquid separation space, and wherein an upper portion of the solid-liquid separation space is configured to provide the second stream for introduction into the electrodialysis reversal apparatus.

10. The desalination system of claim 9, wherein a rising rate in the solid-liquid separation space of the precipitation unit is greater than about 0.5 gallon per minute per square feet.

11. The desalination method of claim 9, wherein a rising rate in the solid-liquid separation space of the precipitation unit is greater than about 1.0 gallon per minute per square feet.

12. A desalination method, comprising:
passing a first stream through an electrodialysis reversal apparatus for desalination;
passing a second stream through the electrodialysis reversal apparatus via a precipitation unit to carry away ions removed from the first stream; and
filtering the second stream by at least one backwashable filter in a normal operation mode before the second stream from the precipitation unit is introduced into the electrodialysis reversal apparatus.

13. The desalination method of claim 12, wherein the precipitation unit comprises a solid-liquid separation space, and wherein the second stream is extracted from an upper portion of the solid-liquid separation space for introduction into the electrodialysis reversal apparatus in the normal operation mode of the at least one backwashable filter.

14. The desalination method of claim 13, wherein a rising rate in the solid-liquid separation space of the precipitation unit is greater than about 0.5 gallon per minute per square feet when the second stream is extracted from the upper portion of the solid-liquid separation space for introduction into the electrodialysis reversal apparatus.

15. The desalination method of claim 13, wherein a rising rate in the solid-liquid separation space of the precipitation unit is greater than about 1.0 gallon per minute per square feet when the second stream is extracted from the upper portion of the solid-liquid separation space for introduction into the electrodialysis reversal apparatus.

16. The desalination method of claim 12, further comprising passing a washing fluid through the at least one backwashable filter in a backwash mode to produce a discharge fluid.

17. The desalination method of claim 16, further comprising introducing the discharge fluid into the precipitation unit, and wherein the washing fluid and the first stream are provided by is provided by the same liquid source.

18. The desalination method of claim 12, further comprising filtering the second stream from the at least one backwashable filter via a filter disposed between and in fluid communication with the at least one backwashable filter and the electrodialysis reversal apparatus.

19. The desalination method of claim 18, wherein the filter comprises a cartridge filter.

20. The desalination method of claim 12, wherein a plurality of backwashable filters are disposed in parallel with each other to filter the second stream.
